(19) United States
(12) Patent Application Publication
(10) Pub. No.: US 2026/0227524 A1
(43) Pub. Date: Aug. 6, 2026

(54) DOPPLER MEASUREMENT

(71) Applicant: QUALCOMM Incorporated, San Diego, CA (US)

(72) Inventors: Lianghai JI, San Diego, CA (US); Weimin DUAN, San Diego, CA (US)

(21) Appl. No.: 19/045,056

(22) Filed: Feb. 4, 2025

(51) Int. Cl. G01S 19/25; G01S 19/46

(52) U.S. Cl. CPC G01S 19/254; G01S 19/46

(57) ABSTRACT

A method of wireless positioning performed by a user equipment (UE) comprises receiving, from a location management function (LMF), a doppler shift measurement indicator indicating to perform or not perform one or more doppler shift measurements on one or more reference signals for positioning (RS-Ps), and determining whether to perform the one or more doppler shift measurements on the one or more RS-Ps based on the doppler shift measurement indication.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a user equipment (UE) comprises: receiving, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

In an aspect, a user equipment (UE) comprises: one or more memories; one or more transceivers; and one or more processors communicatively coupled to the one or more memories and the one or more transceivers, the one or more processors, either alone or in combination, configured to: receive, via the one or more transceivers, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

In an aspect, a user equipment (UE) comprises: means for receiving, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

In an aspect, a non-transitory computer-readable medium stores computer-executable instructions that, when executed by a user equipment (UE), cause the UE to: receive, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

In an aspect, a method of wireless positioning performed by a user equipment (UE) comprises: receiving, from a location management function (LMF), a measurement configuration indicating one or more reference signals for positioning (RS-Ps); performing one or more doppler shift measurements on the one or more RS-Ps while a timer is running; and stopping performance of the one or more doppler shift measurements based on the timer expiring.

In an aspect, a user equipment (UE) comprises: one or more memories; one or more transceivers; and one or more processors communicatively coupled to the one or more memories and the one or more transceivers, the one or more processors, either alone or in combination, configured to: receive, via the one or more transceivers, from a location management function (LMF), a measurement configuration indicating one or more reference signals for positioning (RS-Ps); perform one or more doppler shift measurements on the one or more RS-Ps while a timer is running; and stop performance of the one or more doppler shift measurements based on the timer expiring.

In an aspect, a user equipment (UE) comprises: means for receiving, from a location management function (LMF), a measurement configuration indicating one or more reference signals for positioning (RS-Ps); means for performing one or more doppler shift measurements on the one or more RS-Ps while a timer is running; and means for stopping performance of the one or more doppler shift measurements based on the timer expiring.

In an aspect, a non-transitory computer-readable medium stores computer-executable instructions that, when executed by a user equipment (UE), cause the UE to: receive, from a location management function (LMF), a measurement configuration indicating one or more reference signals for positioning (RS-Ps); perform one or more doppler shift measurements on the one or more RS-Ps while a timer is running; and stop performance of the one or more doppler shift measurements based on the timer expiring.

In an aspect, a method of wireless positioning performed by a user equipment (UE) comprises: receiving, via the one or more transceivers, from a location management function (LMF), a measurement configuration indicating: one or more reference signals for positioning (RS-Ps); and one or more conditions for performing one or more doppler shift measurements on the one or more RS-Ps; and performing one or more doppler shift measurements on the one or more RS-Ps based on the one or more conditions being met.

In an aspect, a user equipment (UE) comprises: one or more memories; one or more transceivers; and one or more processors communicatively coupled to the one or more memories and the one or more transceivers, the one or more processors, either alone or in combination, configured to: receive, via the one or more transceivers, via the one or more transceivers, from a location management function (LMF), a measurement configuration indicating: one or more reference signals for positioning (RS-Ps); and one or more conditions for performing one or more doppler shift measurements on the one or more RS-Ps; and perform one or more doppler shift measurements on the one or more RS-Ps based on the one or more conditions being met.

In an aspect, a user equipment (UE) comprises: means for receiving, via the one or more transceivers, from a location management function (LMF), a measurement configuration indicating: one or more reference signals for positioning (RS-Ps); and one or more conditions for performing one or more doppler shift measurements on the one or more RS-Ps; and means for performing one or more doppler shift measurements on the one or more RS-Ps based on the one or more conditions being met.

In an aspect, a non-transitory computer-readable medium stores computer-executable instructions that, when executed by a user equipment (UE), cause the UE to: receive, via the one or more transceivers, from a location management function (LMF), a measurement configuration indicating: one or more reference signals for positioning (RS-Ps); and one or more conditions for performing one or more doppler shift measurements on the one or more RS-Ps; and perform one or more doppler shift measurements on the one or more RS-Ps based on the one or more conditions being met.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates an example of satellite coverages of a medium earth orbit (MEO) satellite and a low earth orbit (LEO) satellite, according to aspects of the disclosure.

FIG. 5 illustrates a signal flow diagram for dynamic control of doppler measurements, in accordance with aspects of the disclosure.

FIGS. 6A and 6B illustrate timing diagrams for a timer-based mechanism for performing or not performing doppler measurements

FIG. 7 illustrates a signal flow diagram for dynamic control of doppler measurements, in accordance with aspects of the disclosure.

FIG. 8 illustrates a signal flow diagram for dynamic control of doppler measurements, in accordance with aspects of the disclosure.

FIGS. 9 to 11 illustrate example methods of wireless positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to doppler measurements. Some aspects more specifically relate to performing or not performing doppler measurements. In some examples, a user equipment (UE) receives, from a location management function (LMF), a measurement configuration indicating one or more reference signals for positioning (RS-Ps) and an indication to perform or not perform one or more doppler shift measurements on the one or more RS-Ps. In some examples, the UE performs measurements on the one or more RS-Ps based on the indication to perform or not perform the one or more doppler shift measurements.

Particular aspects of the subject matter described in this disclosure can be implemented to realize one or more of the following potential advantages. In some examples, by dynamically determining to perform or not perform doppler measurements, the described techniques can be used to perform high-accuracy positioning (using doppler-based positioning) or to conserve power (by avoiding doppler-based positioning). The determination may be made at the device side or the network side. The determination may consider the marginal cost of performing doppler-based positioning, the marginal benefit of performing doppler-based positioning, an accuracy target associated with a positioning, or any other suitable factors. Performance and/or non-performance of doppler-based positioning may be based on explicit signaling, timing mechanisms, conditions, or any combination thereof, as will be discussed in greater detail below.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

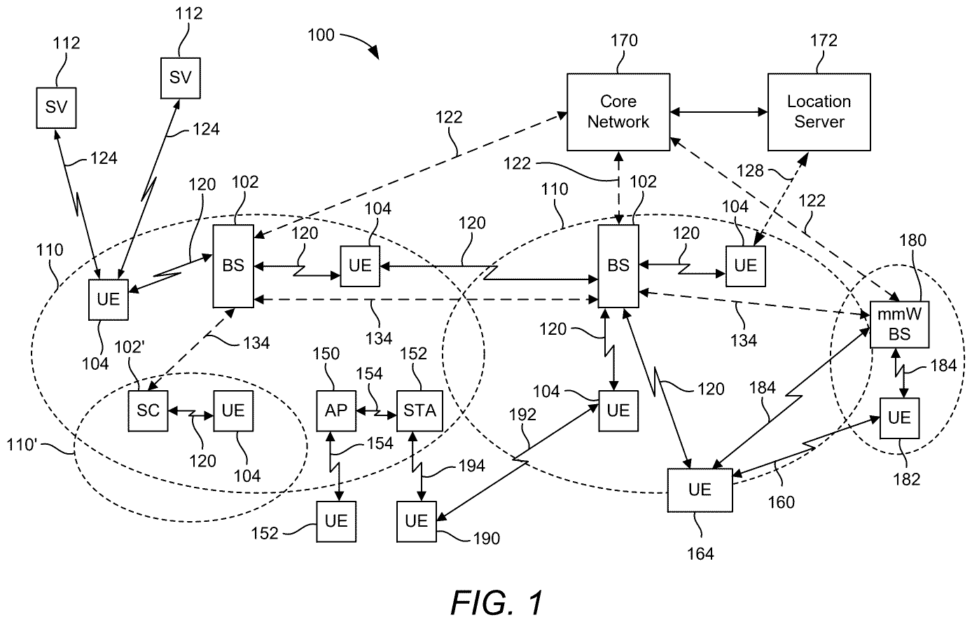

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz 114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1: M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

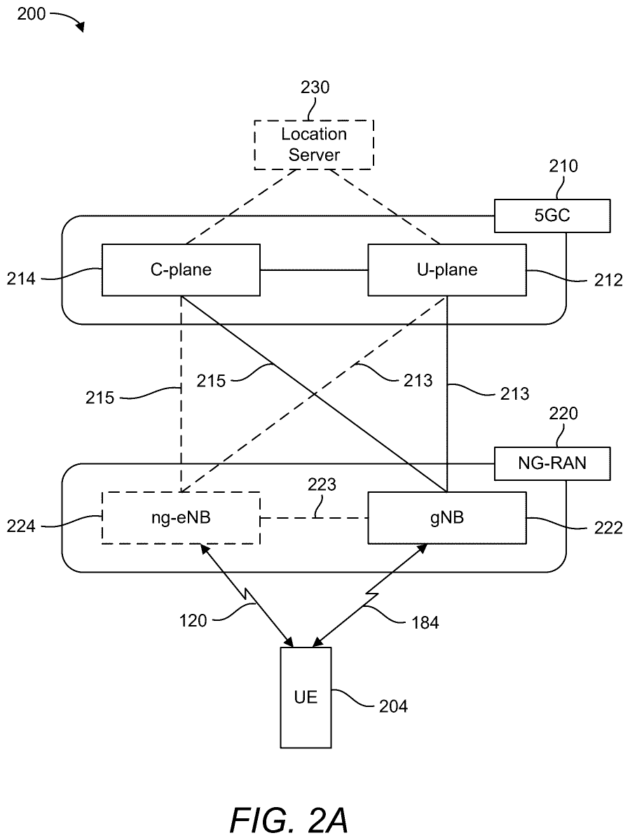

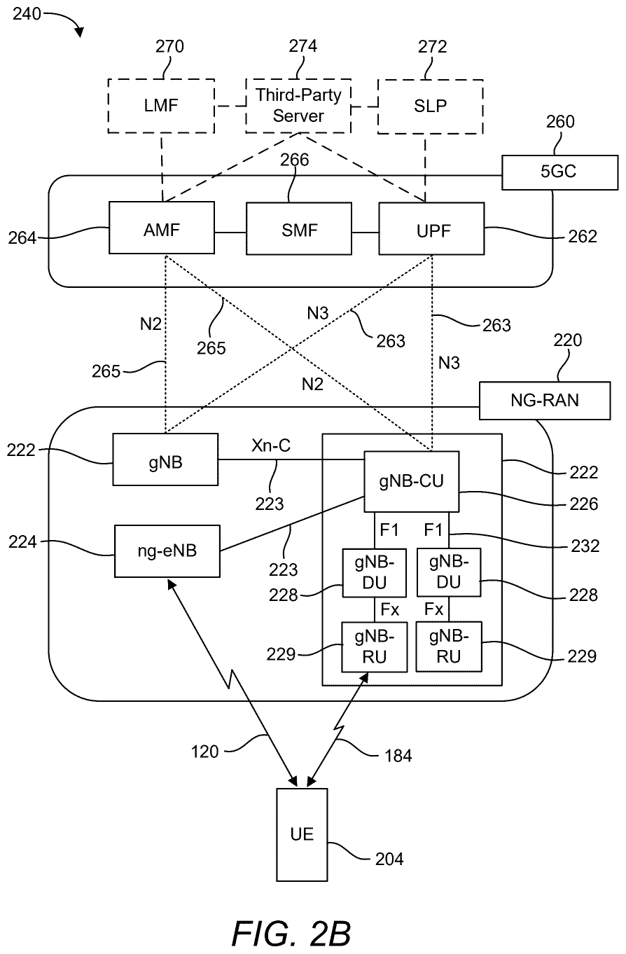

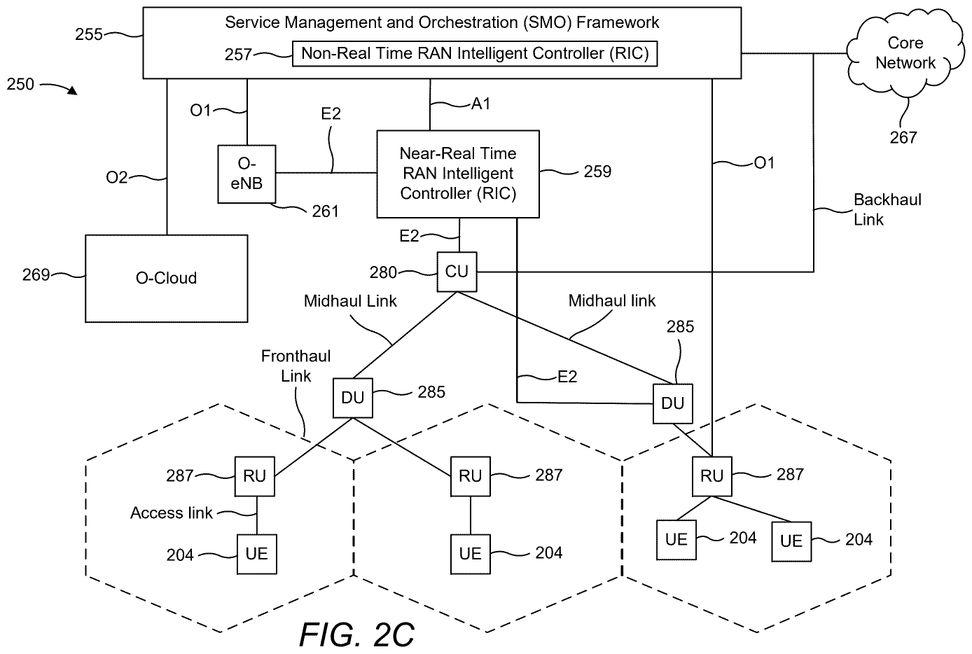

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

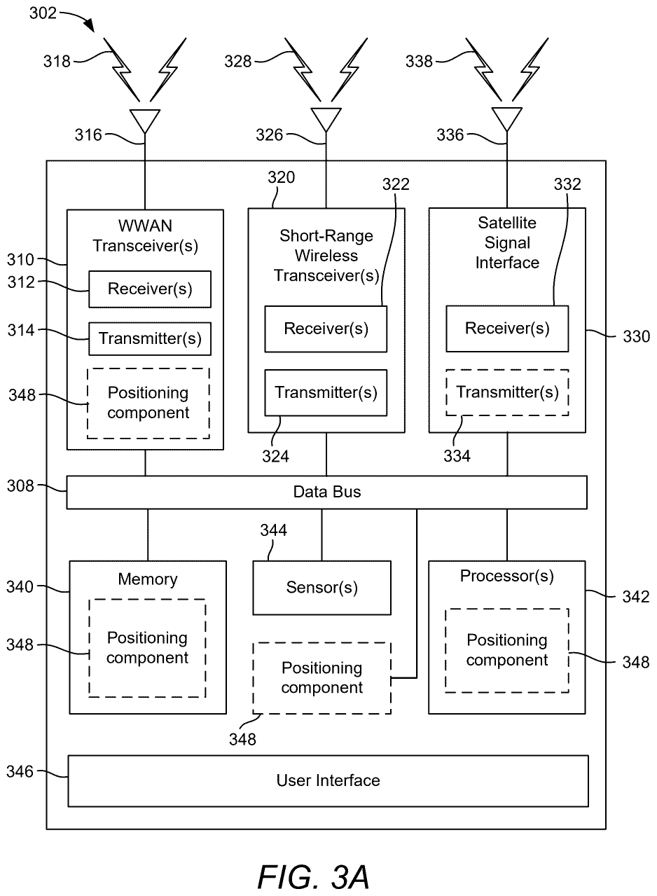

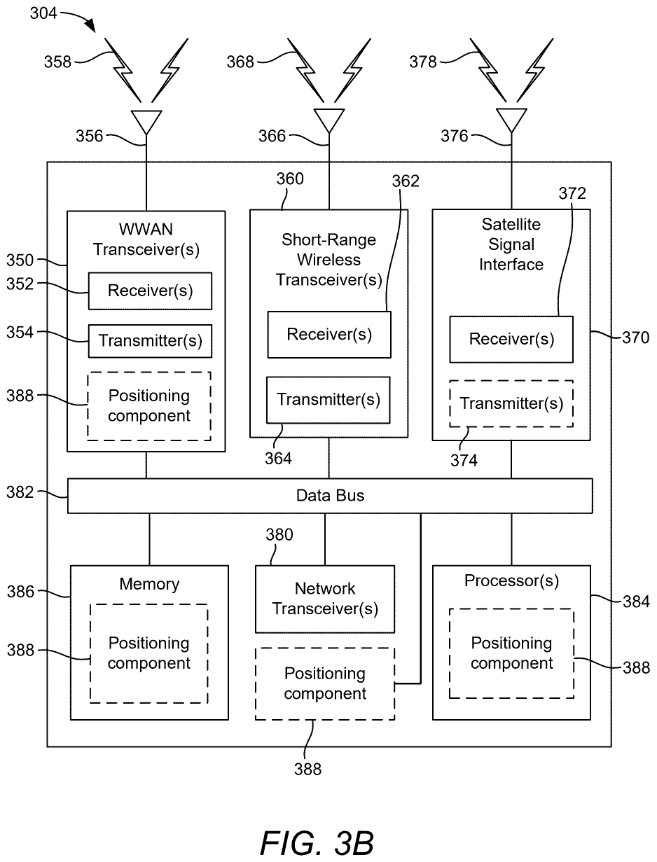

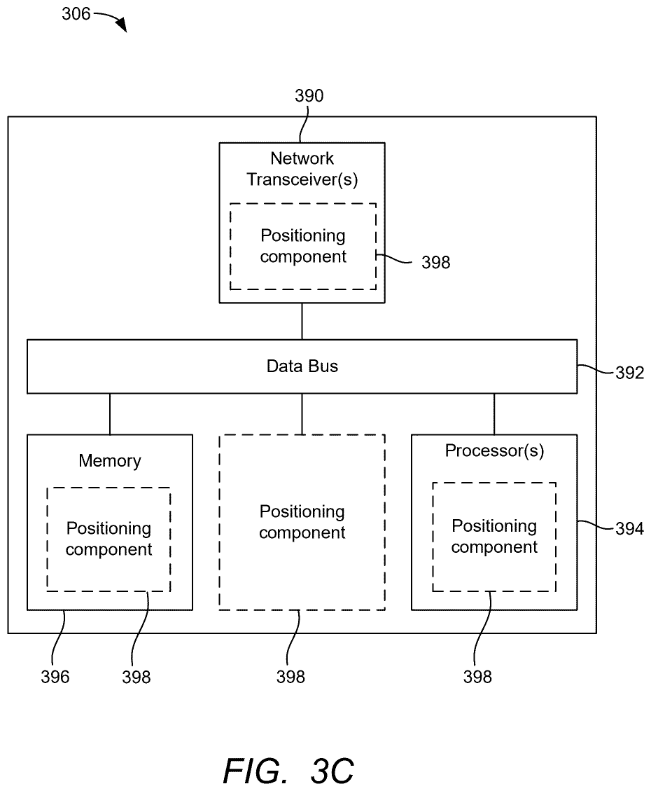

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 348, 388, and 398, respectively. The positioning component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

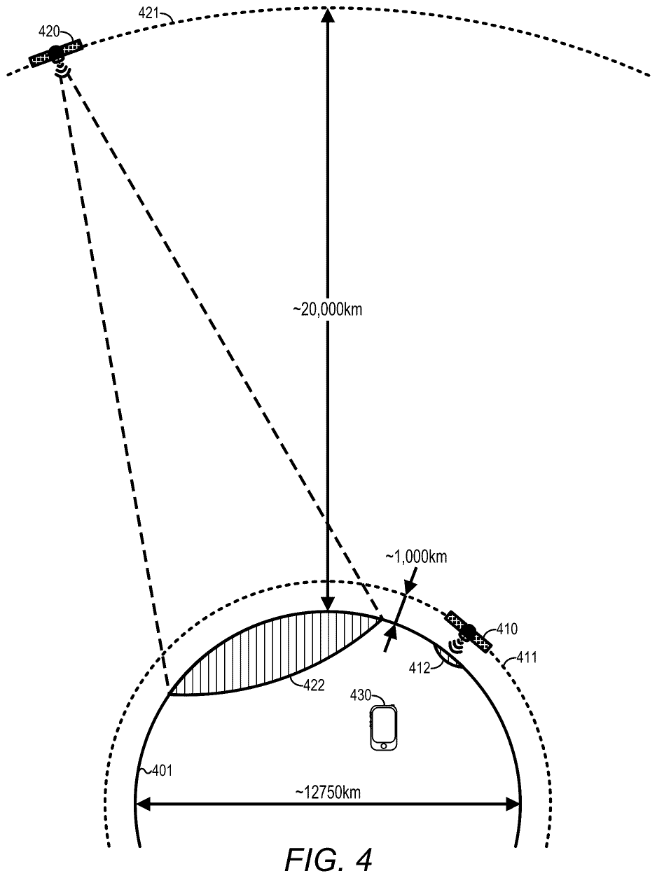

FIG. 4 illustrates an example of satellite coverages of a medium earth orbit (MEO) satellite and a low earth orbit (LEO) satellite, according to aspects of the disclosure. The figure includes earth 401, a LEO satellite 410, a MEO satellite 420, and a user equipment (UE) 430.

LEO satellite 410 orbits earth 401 in a LEO orbit 411 and has a LEO coverage area 412. MEO satellite 420 orbits earth 401 in a MEO orbit 421 and has a MEO coverage area 422. As shown in the figure, earth 401 has a diameter of roughly twelve thousand seven hundred and fifty kilometers. The LEO orbit 411 and MEO orbit 421 may vary significantly, but in the illustrated example, the LEO orbit 411 of LEO satellite 410 is approximately one thousand kilometers from the surface of earth 401, whereas the MEO orbit 421 of MEO satellite 420 is approximately twenty thousand kilometers from the surface of earth 401. The LEO coverage area 412 and MEO coverage area 422 illustrated in FIG. 4 are not to scale, but it will be understood that the MEO coverage area 422 may be larger than the LEO coverage area 412.

Satellites such as LEO satellite 410 and MEO satellite 420 may be included in one or more non-terrestrial networks (NTNs). Satellites such as LEO satellite 410 and MEO satellite 420 may transmit (e.g., broadcast) reference signals that can be used for positioning. For example, UE 430 may receive and/or measure reference signals from one or more satellites (LEO and/or MEO). The position of UE 430, with or without assistance from wireless network components, may be determined based on the one or more measurements of the reference signals from the one or more satellites. For example, UE 430 may receive reference signals from four or more satellites and determine, based on a measurement of the reference signals, a range or distance from each satellite. By combining the range measurements and the known positions of each satellite, UE 430 may determine its position.

A global navigation satellite system (GNSS) may comprise several dozen satellites. Existing GNSSs include global positioning system (GPS), Galileo, global navigation satellite system (GLONASS), and BeiDou navigation satellite system (BDS). These GNSSs rely on MEO satellites arranged similarly to MEO satellite 420 in MEO orbit 421.

The accuracy of range-based positioning varies based on a variety of factors, including, for example, a number of visible satellites. Satellite visibility may be high in some scenarios and low in others. For example, in an ideal open-sky scenario, UE 430 may have a direct and unobstructed line of sight to ten satellites, but in other scenarios, only one or two satellites may be visible to UE 430. For example, in an urban canyon scenario, tall buildings may block the line of sight to most satellites, weakening the signal strength of the received reference signals, and preventing an accurate positioning determination.

Another method of positioning involves doppler measurements of reference signals. Doppler measurements use a frequency shift of a transmitted signal to determine a relative velocity of the receiver and transmitter. For example, a satellite can transmit a reference signal having a particular known transmission frequency, and the UE 430 can receive the reference signal. If the frequency of the received signal is shifted relative to the transmission frequency, then this implies a relative velocity difference between the transmitter and the receiver (e.g., the satellite and the UE 430).

In accordance with aspects of the disclosure, positioning techniques may use range-based positioning and doppler-based positioning. For example, doppler-based positioning may be used to augment range-based positioning (e.g., to improve accuracy).

Any satellite, LEO or MEO, may perform range-based positioning, doppler-based positioning, or both. In some scenarios, MEO satellites are better suited to range-based positioning due to being more stable relative to earth 401. In particular, since MEO orbit 421 is further from earth 401, MEO satellites such as MEO satellite 420 cover a larger area and move more slowly. In some scenarios, LEO satellites are better suited to doppler-based positioning due to the high speed and high signal strength associated with being nearer to the surface of earth 401.

Doppler-based positioning can improve positioning performance, but may come at a high cost in terms of power and resource consumption. For example, doppler measurements may require that a strong signal be measured for a long period of time. If there is a need to improve performance, and doppler-based positioning is able to deliver the improvement, then the improvement may be worth the cost.

Consider, as an example, a scenario where a wireless device such as UE 430 is using a GNSS system (relying on MEO satellites such as MEO satellite 420) to perform range-based positioning. The UE 430 may have a particular target performance level that the range-based positioning is failing to meet. For example, UE 430 may be in a challenging environment (e.g., urban canyon scenario with limited satellite visibility) and/or the target performance level may be very high (e.g., due to the particular positioning use-case of UE 430). Moreover, one or more satellites (e.g., LEO satellites configured to provide suitable reference signals) may be available for doppler-based positioning. In such a scenario, UE 430 doppler-based positioning may augment the range-based positioning results, and UE 430 may benefit from doppler-based positioning despite the cost.

However, the needs of UE 430 and the surrounding conditions may change rapidly. As an example, suppose that the use-case of UE 430 only requires a few high-accuracy data points relating to position. As another example, suppose that UE 430 moves out of the urban canyon scenario, and range-based positioning suddenly provides adequate performance. In such a case, the assistance provided by doppler-based positioning is no longer needed, and it is no longer worthwhile to pay the cost.

In accordance with aspects of the disclosure, utilization of doppler-based positioning may be dynamically controlled to avoid waste. In the following examples, one or more MEO satellites provide range-based positioning for a UE, which is augmented by doppler-based positioning provided by one or more LEO satellites. However, it will be understood that this is merely for illustration, and that the mechanisms for dynamic control of doppler measurements disclosed herein may be advantageously implemented in any number of contexts. For example, doppler-based positioning can be provided by non-LEO satellites, or by transmitting devices that are not satellites at all. Moreover, doppler-based positioning may be used for standalone positioning purposes, rather than to augment some other form of positioning (e.g., range-based positioning). Moreover, any positioning method (not necessarily range-based positioning dependent on MEO satellites) could be augmented by doppler-based positioning, for example, network-based positioning such as time difference of arrival (TDOA), roundtrip time (RTT), enhanced cell identity (ECID), etc.

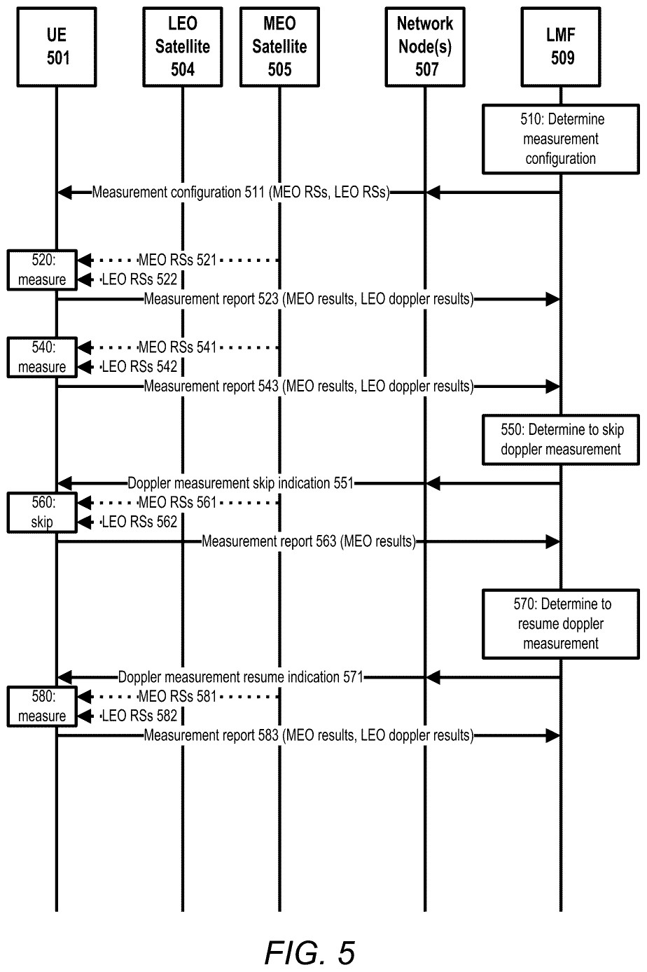

FIG. 5 illustrates a signal flow diagram for dynamic control of doppler measurements, in accordance with aspects of the disclosure. In the figure are a UE 501, a LEO satellite 504, a MEO satellite 505, one or more network nodes 507 (e.g., one or more base stations, evolved node Bs (eNBs), next generation node Bs (gNBs), etc.), and a location management function (LMF) 509. In the present example, one or more satellites used for range-based positioning are represented by MEO satellite 505, and one or more satellites used for doppler-based positioning are represented by LEO satellite 504, but it will be understood that this is merely an example provided for illustrative purposes.

At 510, LMF 509 determines a measurement configuration. The measurement configuration may be provided to LEO satellite 504, MEO satellite 505, UE 501, any number of other UEs, or any combination thereof.

LMF 509 sends measurement configuration 511 to UE 501 (e.g., via the one or more network nodes 507). The measurement configuration 511 may configure UE 501 to receive and/or measure one or more reference signals for positioning (RS-P). In the illustrated example, the configured RS-Ps include one or more reference signals of the LEO satellite 504 (LEO RSs in the illustration) and one or more reference signals of the MEO satellite 505 (MEO RSs in the illustration).

In an example, measurement configuration 511 indicates to receive and/or measure the configured RS-Ps at particular times (e.g., at a particular start time and at a particular periodicity), indicates to report one or more measurement results associated with the RS-Ps at a particular time and/or periodicity, and/or provides one or more events/conditions to trigger the UE to report the measurement results.

At 520, UE 501 measures one or more MEO RSs 521 received from MEO satellite 505 and one or more LEO RSs 522 received from LEO satellite 504. The measuring at 520 may be based on the measurement configuration 511 received from LMF 509.

UE 501 sends a measurement report 523 to LMF 509 (e.g., via the one or more network nodes 507). The measurement report 523 may include one or more measurement results of the RS-Ps configured by measurement configuration 511 (e.g., the one or more MEO RSs 521 and/or the one or more LEO RSs 522). In the illustrated example, the measurement report 523 includes one or more measurement results of the one or more MEO RSs 521 used for range-based positioning, and one or more measurement reports of the one or more LEO RSs 522 used for doppler-based positioning.

As noted above, in this particular measurement configuration, the doppler-based positioning obtained associated with LEO satellite 504 may augment the accuracy of the range-based positioning obtained associated with MEO satellite 505. The resulting positioning performance may be associated with a high level of accuracy. The improved performance may come at a high cost in terms of power and resources. According to the measurement configuration 511, the measurements may continue indefinitely.

At 540, similar to 520, UE 501 measures one or more MEO RSs 541 received from MEO satellite 505 and one or more LEO RSs 542 received from LEO satellite 504. UE 501 sends a measurement report 543 to LMF 509 (similar to measurement report 523).

At 550, LMF 509 determines that one or more UEs (e.g., UE 501) should skip one or more doppler measurements. As an example, LMF 509 may determine that the higher level of accuracy delivered by the doppler-based positioning is not worth the cost of obtaining the doppler measurements. The determination may be based on any suitable factors, for example, a determination that the high level of accuracy is not needed, a determination that range-based positioning can provide the high level of accuracy without augmentation by the doppler-based positioning, or any combination thereof.

LMF 509 sends a doppler measurement skip indication 551 to UE 501 (e.g., via one or more network nodes 507). The sending of the doppler measurement skip indication 551 may be based on the determining at 550. The doppler measurement skip indication 551 may be an indication to perform or not perform one or more doppler shift measurements on one or more RS-Ps (e.g., the RS-Ps configured in measurement configuration 511).

In an example, doppler measurement skip indication 551 may indicate to skip at least a next doppler shift measurement of the one or more doppler shift measurements. For example, the measurement configuration 511 may indicate periodic sets of doppler measurements, and the doppler measurement skip indication 551 may indicate to skip the next scheduled set of doppler measurements.

Additionally or alternatively, doppler measurement skip indication 551 may indicate to start skipping doppler shift measurements. For example, the measurement configuration 511 may indicate that doppler measurements continue for a set duration or indefinitely, and the doppler measurement skip indication 551 may indicate to skip all remaining doppler measurements. (As will be discussed in greater detail below, there may be a mechanism to resume the doppler measurements.)

Additionally or alternatively, doppler measurement skip indication 551 may indicate a skipping start time, a skipping end time, a skipping time duration, or any combination thereof. For example, doppler measurement skip indication 551 may define a skipping window during which doppler measurements are not performed. UE 501 may skip configured doppler shift measurements that would have otherwise occurred during the skipping window. UE 501 may resume doppler shift measurements after the skipping window indicated by doppler measurement skip indication 551.

In an example, doppler measurement skip indication 551 may indicate a particular satellite (e.g., comprise a satellite identifier of the particular satellite). For example, UE 501 may be configured to perform doppler measurements associated with a plurality of configured satellites, and doppler measurement skip indication 551 may indicate to skip doppler measurement associated with the particular satellite (rather than, for example, all of the configured satellites).

In an example, doppler measurement skip indication 551 may indicate a particular location (e.g., a geographic area, a geographic zone, a position and distance from the position, a coverage area of a serving cell, a coverage area of a serving beam). The location may be indicated with a range of latitudes, a range of longitudes, a range of elevations, or any combination thereof. Additionally or alternatively, the location may be indicated with a latitude, longitude, elevation, or any combination thereof, and a distance therefrom. Additionally or alternatively, the location may be indicated with a tracking area identifier, registration area identifier, cell group identifier, cell identifier, beam identifier, or any combination thereof. For example, UE 501 may be configured to perform doppler measurements irrespective of location, and doppler measurement skip indication 551 may indicate to skip doppler measurements based on being at the location indicated by the doppler measurement skip indication 551. Alternatively, doppler measurement skip indication 551 may indicate to skip doppler measurements based on not being at the location indicated by the doppler measurement skip indication 551.

At 560, UE 501 skips one or more doppler measurements. The skipping at 560 may be based on the doppler measurement skip indication 551 received from LMF 509. During the skipping at 560, UE 501 may perform other configured positioning. For example, UE 501 may measure the one or more MEO RSs 561 configured by the measurement configuration 511 irrespective of the doppler measurement skip indication 551.

In an example (not illustrated), additionally or alternatively, doppler measurement skip indication 551 may be sent to LEO satellite 504. Based on receiving doppler measurement skip indication 551, LEO satellite 504 may skip transmission of the one or more LEO RSs 562.

UE 501 sends a measurement report 563 to LMF 509. The measurement report 563 may contain, for example, one or more measurement results associated with the one or more MEO RSs 561. The measurement report 563 may not contain any measurement results associated with the one or more LEO RSs 562, which are skipped as a result of the doppler measurement skip indication 551.

At 570, LMF 509 determines that one or more UEs (e.g., UE 501) should resume one or more doppler measurements. As an example, LMF 509 may determine that the higher level of accuracy delivered by the doppler-based positioning is worth the cost of obtaining the doppler measurements. The determination may be based on any suitable factors, for example, a determination that the high level of accuracy is needed, a determination that range-based positioning can not provide the high level of accuracy without augmentation by the doppler-based positioning, or any combination thereof.

LMF 509 sends a doppler measurement resume indication 571 to UE 501 (e.g., via one or more network nodes 507). The sending of the doppler measurement resume indication 571 may be based on the determining at 570. The doppler measurement resume indication 571 may be an indication to perform or not perform one or more doppler shift measurements on one or more RS-Ps (e.g., the RS-Ps configured in measurement configuration 511).

In an example, doppler measurement resume indication 571 may indicate to perform at least a next doppler shift measurement of the one or more doppler shift measurements. For example, the measurement configuration 511 may indicate periodic sets of doppler measurements, and the doppler measurement resume indication 571 may indicate to perform the next scheduled set of doppler measurements.

Additionally or alternatively, doppler measurement resume indication 571 may indicate to resume doppler shift measurements. For example, the measurement configuration 511 may indicate that doppler measurements continue for a set duration or indefinitely, and doppler measurement resume indication 571 may indicate to perform all remaining doppler measurements.

Additionally or alternatively, doppler measurement resume indication 571 may indicate a resume start time, a resume end time, a resume time duration, or any combination thereof. For example, doppler measurement resume indication 571 may define a resume window during which doppler measurements are performed. UE 501 may perform configured doppler shift measurements that would have otherwise been skipped (e.g., based on receiving the doppler measurement skip indication 551). UE 501 may stop (e.g., begin skipping) doppler shift measurements after the resume window indicated by doppler measurement resume indication 571.

In an example, doppler measurement resume indication 571 may indicate a particular satellite (e.g., comprise a satellite identifier of the particular satellite). For example, UE 501 may be skipping doppler measurements associated with a plurality of configured satellites, and doppler measurement resume indication 571 may indicate to resume doppler measurement associated with the particular satellite (rather than, for example, all of the configured satellites).

In an example, doppler measurement resume indication 571 may indicate a particular location (e.g., indicate a particular location as described above with respect to doppler measurement skip indication 551). For example, UE 501 may be configured to perform doppler measurements irrespective of location, and doppler measurement resume indication 571 may indicate to perform (e.g., resume) doppler measurements based on being at (or alternatively, based on not being at) the location indicated by the doppler measurement resume indication 571.

In an example, doppler measurement resume indication 571 may indicate a resolution for performing doppler measurements. The measuring at 580 may comprise one or more doppler-based measurements at the resolution indicated by doppler measurement resume indication 571. In an example, a plurality of possible resolutions are preconfigured to UE 501 and/or indicated by the measurement configuration 511, and the doppler measurement resume indication 571 points to one of the plurality of possible resolutions.

At 580, similar to 520 and 540, UE 501 measures one or more MEO RSs 581 received from MEO satellite 505 and one or more LEO RSs 582 received from LEO satellite 504. UE 501 sends a measurement report 583 to LMF 509 (similar to measurement report 523 and measurement report 543).

In the example above, UE 501 begin measurements (range-based and doppler-based) on all reference signals immediately, based on measurement configuration 511. In an example, measurement configuration 511 includes an indication to perform or not perform one or more doppler shift measurements on one or more RS-Ps (e.g., that the UE 501 should initialize in a doppler skipping mode or a doppler measurement mode). For example, measurement configuration 511 may comprise a doppler measurement indication similar to doppler measurement resume indication 571, and the doppler measurements at 520 and 540 may be based on the doppler measurement indication included in measurement configuration 511. Alternatively, measurement configuration 511 may comprise a doppler measurement skip indication similar to doppler measurement skip indication 551, and the UE 501 may initialize in a doppler skipping mode (e.g., until a doppler measurement resume indication 571 is received).

The doppler measurement skip indication 551 and doppler measurement resume indication 571 may respectively be sent and/or received in any suitable message. For example, either or both may be sent and/or received in a downlink control information (DCI). Additionally or alternatively, either or both may be sent and/or received in a medium access control (MAC) control element. Additionally or alternatively, either or both may be sent and/or received in a broadcast message transmitted to a geographic area, geographic zone, coverage area, or any combination thereof. Additionally or alternatively, either or both may be sent and/or received in a system information block (SIB) associated with a cell, a beam, or any combination thereof. Additionally or alternatively, either or both may be sent and/or received in a multicast message transmitted to a group of UEs, a multicast message transmitted to a group of UEs associated with a positioning session, or any combination thereof.

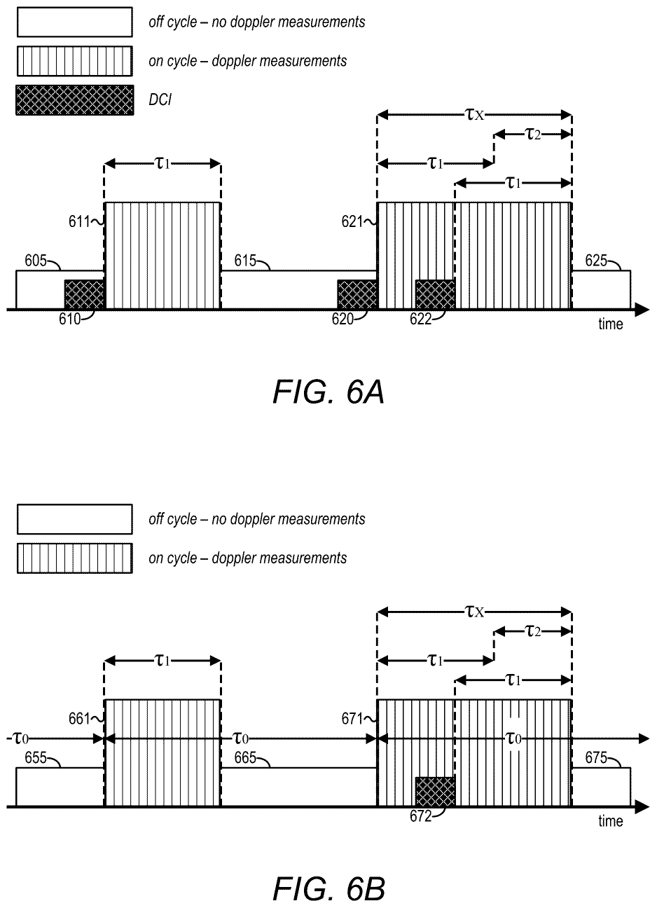

FIGS. 6A and 6B illustrate timing diagrams for a timer-based mechanism for performing or not performing doppler measurements. In both timing diagrams, there are alternating periods where doppler measurements are performed (e.g., an on-cycle) or are not performed (e.g., an off-cycle). The switching from on-cycle to off-cycle or vice-versa may be controlled via one or more timers, control signaling (e.g., downlink control information (DCIs)), or any combination thereof.

Although DCIs are illustrated, it will be understood that any signaling may be used. The doppler measurements may be performed by any device (e.g., any position-sensing device). The control signaling (e.g., DCIs) may be received from the network (e.g., a location management function (LMF)) via one or more network nodes (e.g., base stations).

FIG. 6A illustrates a timing diagram where DCIs indicate to switch from off-cycle to on-cycle and a timer indicates to switch from on-cycle to off-cycle. Moreover, DCIs may indicate to extend an on-cycle.

In the illustration, the timing diagram of FIG. 6A begins in an off-cycle 605. During off-cycle 605 (and all other off-cycles described herein), doppler measurements are not performed. A DCI 610 is received during off-cycle 605. DCI 610 triggers an on-cycle 611. When on-cycle 611 begins (e.g., in response to the triggering by DCI 610), an on-cycle timer is started. The on-cycle timer is associated with a value τ1. As an example, the on-cycle timer starts at τ1 and decrements until it expires. During on-cycle 611 (and all other on-cycles described herein), doppler measurements are performed. Doppler measurements may be performed while the on-cycle timer is running (e.g., based on the on-cycle timer being running).

When the on-cycle timer expires (after τ1 units of time), an off-cycle 615 begins. A DCI 620 is received during off-cycle 615. DCI 620 triggers an on-cycle 621. When on-cycle 621 begins (e.g., in response to the triggering by DCI 620), an on-cycle timer (with value τ1) is started.

During on-cycle 621 (e.g., before the on-cycle timer expires), a DCI 622 is received. DCI 622 triggers an extension of the on-cycle 621. For example, the on-cycle timer is restarted (e.g., with value τ1). After the on-cycle timer expires, an off-cycle 625 begins.

The effect of DCI 622 is that the on-cycle with initial duration of τ1 is extended by a duration of τ2. As a result of the extension, doppler measurements are performed for an extended duration τX, where τX is equal to the sum of τ1 and τ2. It will be understood that in some implementations, repeated DCIs similar to DCI 622 may be used to extend τX indefinitely.

As will be understood from FIG. 6A, in some implementations, switching from off-cycle to on-cycle may be controlled with control signaling (DCIs), and switching from on-cycle to off-cycle may be controlled with timers (e.g., an on-cycle timer). Moreover, extension of an on-cycle may be controlled with control signaling. Accordingly, doppler measurements associated with a positioning session can be initiated and dynamically controlled using DCIs (e.g., when doppler measurements are needed).

FIG. 6B illustrates a timing diagram where timers indicate to switch from off-cycle to on-cycle and to switch from on-cycle to off-cycle. Moreover, DCIs may indicate to extend an on-cycle.

In the illustration, the timing diagram of FIG. 6B begins in an off-cycle 655. A duty-cycle timer expires during off-cycle 655. The duty-cycle timer has a value τ0. As an example, the duty-cycle timer starts at τ0 and runs until it expires. When the duty-cycler timer expires, a new on-cycle begins. When the duty-cycle timer expires, an on-cycle 661 begins, the on-cycle timer starts (e.g., with value τ1), and the duty-cycle timer restarts (e.g., with value τ0).

When the on-cycle timer expires (after τ1 units of time), an off-cycle 665 begins. The duty-cycle timer continues to run. When the duty-cycle timer expires, an on-cycle 671 begins, the on-cycle timer starts (e.g., with value τ1), and the duty-cycle timer restarts (e.g., with value τ0).

Similar to FIG. 6A, a DCI 672 is received. DCI 672 triggers an extension of the on-cycle 671. For example, the on-cycle timer is restarted (e.g., with value τ1). After the on-cycle timer expires, an off-cycle 675 begins.

The effect of DCI 672 is that the on-cycle with initial duration of τ1 is extended by a duration of τ2. As a result of the extension, doppler measurements are performed for an extended duration τX, where τX is equal to the sum of τ1 and τ2. It will be understood that in some implementations, repeated DCIs similar to DCI 672 may be used to extend τX indefinitely.

As will be understood from FIG. 6B, in some implementations, a duty cycle may be controlled with timers (e.g., a duty-cycle timer and an on-cycle timer). Moreover, extension of an on-cycle may be controlled with control signaling. Accordingly, doppler measurements associated with a positioning session can be initiated and dynamically controlled using DCIs (e.g., when doppler measurements are needed).

It will be understood that in other implementations (not shown), DCIs may be used in a similar manner to extend an off-cycle rather than an on-cycle. In addition, the one or more timer values and the corresponding behavior at the UE may be associated to a particular satellite, a subset of the configured satellites, and/or the entire set of the configured satellites for doppler measurements.

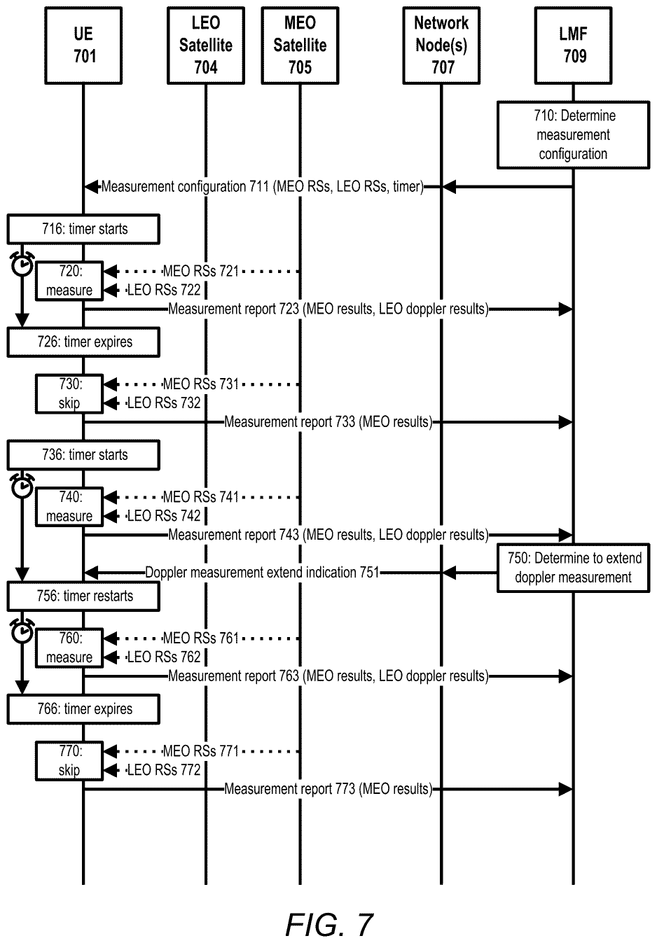

FIG. 7 illustrates a signal flow diagram for dynamic control of doppler measurements, in accordance with aspects of the disclosure. In the figure are a UE 701, a LEO satellite 704, a MEO satellite 705, one or more network nodes 707, and a LMF 709. These components may be similar to analogous components described previously, and further description will be omitted for brevity.

At 710, LMF 709 determines a measurement configuration. The measurement configuration may be provided to LEO satellite 704, MEO satellite 705, UE 701, any number of other UEs, or any combination thereof.

LMF 709 sends measurement configuration 711 to UE 701 (e.g., via the one or more network nodes 707). The measurement configuration 711 may be analogous to the measurement configuration 511 described above. Additionally or alternatively, measurement configuration 711 may comprise one or more timer values. The one or more timer values may indicate a length of time for performing one or more doppler measurements (e.g., τ1 as described above), a length of time for not performing one or more doppler measurements, a length of time between start times of doppler measurements (e.g., τ0 as described above), or any combination thereof. In an example, the one or more timer values may indicate a duty cycle, wherein doppler measurements are performed during a first (‘on’) portion of the duty cycle, and doppler measurements are not performing during a second (‘off’) portion of the duty cycle.

At 716, UE 701 starts a timer (e.g., a first timer analogous to τ1 as described above). After starting at 716, the first timer may run until it expires. A first timer value associated with the first timer may be received in and/or indicated by measurement configuration 711. The first timer may be associated with an on-cycle for performing one or more doppler measurements. For example, when the first timer is running, UE 701 may perform doppler measurements, and when the first timer expires, UE 701 may stop performing doppler measurements.

At 720, UE 701 measures one or more MEO RSs 721 received from MEO satellite 705 (e.g., for range-based positioning) and one or more LEO RSs 722 received from LEO satellite 704 (e.g., for doppler-based positioning). The measuring at 720 may be based on the measurement configuration 711 received from LMF 709. The measuring at 720 of the one or more LEO RSs 722 (for doppler-based positioning) may be based on a determination that the first timer started at 716 is running.

UE 701 sends a measurement report 723 to LMF 709 (e.g., via the one or more network nodes 707). The measurement report 723 may include one or more measurements of the RS-Ps configured by measurement configuration 711 (e.g., the one or more MEO RSs 721 and/or the one or more LEO RSs 722). In the illustrated example, the measurement report 723 includes one or more measurement results of the one or more MEO RSs 721 used for range-based positioning, and one or more measurement reports of the one or more LEO RSs 722 used for doppler-based positioning.

At 726, the timer (e.g., the first timer) expires. In an example, the timer may start at a particular value (e.g., a value that is preconfigured to UE 701 and/or received in measurement configuration 711) and run down to zero, at which point the timer expires. In another example, the timer may start at zero and run up to the particular value, at which point the timer expires. The expiration of the first timer may mark the end of the on-cycle for performing one or more doppler measurements.

At 730, UE 701 skips one or more doppler measurements. The skipping at 730 may be based on the timer expiring at 726. As an example, UE 701 does not measure the LEO RSs 732 transmitted by LEO satellite 704.

During the skipping at 730, UE 701 may perform other configured positioning. For example, UE 701 may measure the one or more MEO RSs 731 configured by the measurement configuration 711 irrespective of the timer expiring at 726.

Additionally or alternatively, in an example (not illustrated), LEO satellite 704 may observe the same duty cycle as UE 701 (e.g., run a timer based on a similar value). Based on the timer expiring, LEO satellite 704 may skip transmission of the one or more LEO RSs 762.

UE 701 sends a measurement report 733 to LMF 709. The measurement report 733 may contain, for example, one or more measurement results associated with the one or more MEO RSs 761. The measurement report 733 may not contain any measurement results associated with the one or more LEO RSs 762, which are skipped as a result of the timer expiring at 726.

At 736, the timer (e.g., the first timer) starts again. The starting of the first timer may occur periodically in accordance with the duty cycle (e.g., analogous to the mechanism illustrated in FIG. 6B). For example, a second timer may begin running at 716, and when the second timer expires, the first timer and the second timer may restart. The second timer may correspond to the period of the duty cycle (e.g., τ0 as described above), and the first timer may correspond to the duration of the on-cycle (e.g., τ1 as described above). The duration of the off-cycle may correspond to the difference between the second timer value and the first timer value (e.g., τ0-τ1). Either or both of the first timer value and the second timer value may be preconfigured to UE 701, indicated by measurement configuration 711, or both.

Additionally or alternatively, the starting may be based on receiving an indication to start. The indication may be similar to the doppler measurement resume indication 571, the DCI 610, and/or the DCI 620 described above.

At 740, similar to the measuring at 720, UE 701 measures one or more MEO RSs 741 received from MEO satellite 705 and one or more LEO RSs 742 received from LEO satellite 704. The measuring at 740 of the one or more LEO RSs 742 may be based on a determination that the first timer is running. UE 701 sends a measurement report 743 to LMF 709 (e.g., via the one or more network nodes 707). The measurement report 743 may be analogous to measurement report 723 described above.

At 750, LMF 709 determines that one or more UEs (e.g., UE 701) should extend one or more doppler measurements. As an example, LMF 709 may determine (e.g., based on measurement report 743) that the doppler-based positioning is generating high-accuracy results and that further doppler measurements will be worthwhile. The determination may be based on any suitable factors, for example, a determination that the high accuracy is needed, a determination that range-based positioning can not provide the high accuracy without augmentation by the doppler-based positioning, a determination that doppler-based positioning can help to provide the high accuracy, or any combination thereof.

LMF 709 sends a doppler measurement extend indication 751 to UE 701 (e.g., via one or more network nodes 707). The sending of the doppler measurement extend indication 751 may be based on the determining at 750. The doppler measurement extend indication 751 may be an indication to perform one or more doppler shift measurements on one or more RS-Ps (e.g., the RS-Ps configured in measurement configuration 711).

In an example, doppler measurement extend indication 751 may indicate to restart a timer (e.g., an on-cycle timer with value τ1, as described above). Additionally or alternatively, doppler measurement extend indication 751 may indicate a new duty cycle timer value (e.g., τ0′), a new on-cycle timer value (e.g., τ1′), or any combination thereof.

In an example, doppler measurement extend indication 751 may be analogous to the doppler measurement resume indication 571 described above. For example, doppler measurement extend indication 751 may indicate a particular satellite, a particular location, a resolution for performing doppler measurements, etc. For brevity, redundant description will be omitted.

At 756, the timer (e.g., the first timer) restarts. The restarting of the first timer may be based on the doppler measurement extend indication 751.

At 760, similar to the measuring at 720 and the measuring at 740, UE 701 measures one or more MEO RSs 761 received from MEO satellite 705 and one or more LEO RSs 762 received from LEO satellite 704. The measuring at 760 of the one or more LEO RSs 762 may be based on a determination that the first timer is running. UE 701 sends a measurement report 763 to LMF 709 (e.g., via the one or more network nodes 707). The measurement report 763 may be analogous to measurement report 723 and measurement report 743 described above.

At 766, the timer (e.g., the first timer) expires. At 770, UE 701 skips one or more doppler measurements. The skipping at 770 may be based on the timer expiring at 766. As an example, UE 701 does not measure the LEO RSs 772 transmitted by LEO satellite 704.

During the skipping at 770, UE 701 may perform other configured positioning. For example, UE 701 may measure the one or more MEO RSs 771 configured by the measurement configuration 711 irrespective of the timer expiring at 766. UE 701 sends a measurement report 773 to LMF 709. The measurement report 773 may be analogous to measurement report 733.

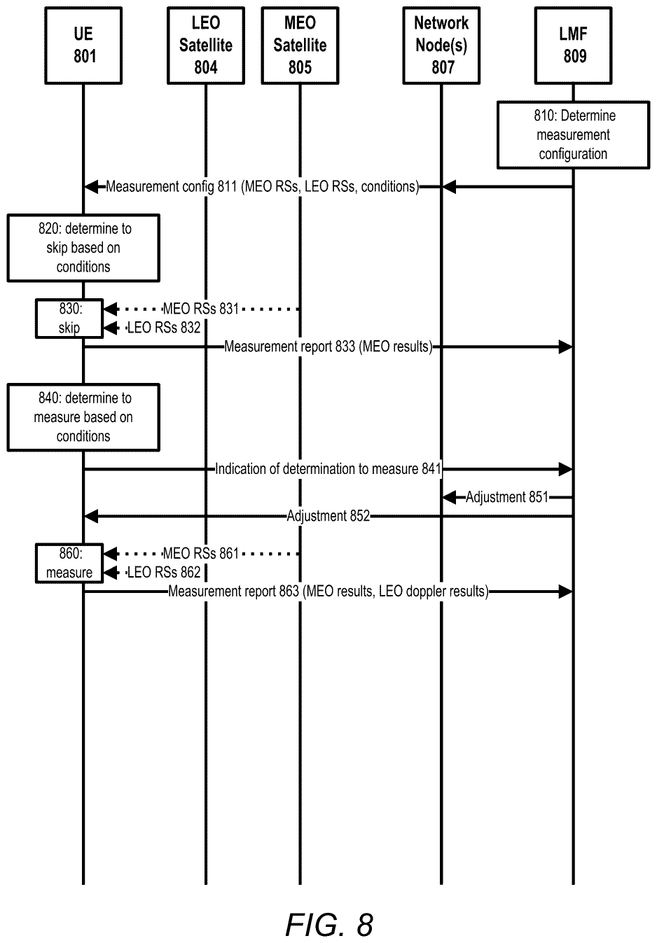

FIG. 8 illustrates a signal flow diagram for dynamic control of doppler measurements, in accordance with aspects of the disclosure. In the figure are a UE 801, a LEO satellite 804, a MEO satellite 805, one or more network nodes 807, and a LMF 809. These components may be similar to analogous components described previously, and further description will be omitted for brevity.

At 810, LMF 809 determines a measurement configuration. The measurement configuration may be provided to LEO satellite 804, MEO satellite 805, UE 801, any number of other UEs, or any combination thereof.

LMF 809 sends measurement configuration 811 to UE 801 (e.g., via the one or more network nodes 807). The measurement configuration 811 may be analogous to the measurement configuration 511 and/or measurement configuration 711 described above. Additionally or alternatively, measurement configuration 811 may indicate one or more conditions. At least one of the one or more conditions may be associated with performance of one or more doppler measurements. Additionally or alternatively, at least one of the one or more conditions may be associated with non-performance of one or more doppler measurements.

At 820, UE 801 determines to skip doppler measurements based on the one or more conditions. The one or more conditions may be indicated by the measurement configuration 811.

In an example, the one or more conditions may relate to a threshold number of visible satellites. The threshold number of visible satellites may be preconfigured to UE 801, indicated by measurement configuration 811, or any combination thereof. UE 801 may determine that a number of visible satellites is greater-than or greater-than-or-equal-to the threshold number of visible satellites. Based on this determination, UE 801 may determine to skip doppler measurements. For example, if many satellites are visible to UE 801, then high accuracy may be obtainable even in the absence of doppler measurements, and the doppler measurements may be skipped.

Additionally or alternatively, the one or more conditions may relate to a threshold signal quality. The threshold signal quality may be preconfigured to UE 801, indicated by measurement configuration 811, or any combination thereof. The threshold signal quality may indicate reference signal received quality (RSRQ), reference signal received power (RSRP), etc. The threshold signal quality may be associated with signals of the range-based positioning. UE 801 may determine that a signal quality of one or more signals associated with range-based positioning is greater-than or greater-than-or-equal-to the threshold signal quality. Based on this determination, UE 801 may determine to skip doppler measurements.

Additionally or alternatively, the one or more conditions may relate to a threshold geometric dilution of precision (GDOP). The threshold GDOP may be preconfigured to UE 801, indicated by measurement configuration 811, or any combination thereof. UE 801 may determine that a GDOP (e.g., a GDOP of one or more satellites associated with range-based positioning) is less-than or less-than-or-equal-to the threshold signal quality. Based on this determination, UE 801 may determine to skip doppler measurements. For example, if GDOP for range-based positioning is low, then high accuracy may be obtainable even in the absence of doppler measurements, and the doppler measurements may be skipped.

At 830, UE 801 skips one or more doppler measurements. The skipping at 830 may be based on the determining at 820. During the skipping at 830, UE 801 may perform other configured positioning. For example, UE 801 may measure the one or more MEO RSs 831 configured by the measurement configuration 811 irrespective of the one or more conditions. UE 801 sends a measurement report 833 to LMF 809. The measurement report 833 may be analogous to the measurement report 733 described above.

At 840, UE 801 determines to perform doppler measurements based on the one or more conditions. The one or more conditions may be indicated by the measurement configuration 811.

As noted above, the one or more conditions may relate to a threshold number of visible satellites, a threshold signal quality, a GDOP, or any combination thereof. for example, at 840, UE 801 may determine that the number of visible satellites is less-than or less-than-or-equal-to the threshold number of visible satellites, that signal quality for range-based positioning is less-than or less-than-or-equal-to the threshold signal quality, that signal quality for range-based positioning is greater-than or greater-than-or-equal-to the threshold signal quality, that GDOP is greater-than or greater-than-or-equal to the threshold GDOP, or any combination thereof. Based on this determination, UE 801 may determine to perform doppler measurements.

UE 801 sends indication of determination to measure 841 to LMF 809. The indication of determination to measure 841 may indicate that one or more doppler measurements have been, are being, and/or will be performed.

The indication of determination to measure 841 may indicate one or more conditions that were met. For example, indication of determination to measure 841 may indicate that one or more doppler measurements are performed due to the number of visible satellites being less-than or less-than-or-equal-to the threshold number of visible satellites, that signal quality being less-than or less-than-or-equal-to the threshold signal quality, that GDOP being greater-than or greater-than-or-equal to the threshold GDOP, or any combination thereof.

The indication of determination to measure 841 may indicate a request for a measurement gap and/or a scheduling restriction (e.g., at the network). For example, based on the determining at 840, UE 801 may perform doppler measurements, and may request that the network configure a measurement gap and/or restrict scheduling of the UE 801 during which the doppler measurements may be performed.

The indication of determination to measure 841 may include one or more results of one or more measurements. The one or more measurements results may relate to range-based positioning, doppler-based positioning, or any combination thereof, and may be based on measurements performed before and/or after the determining at 840. In an example, the indication of determination to measure 841 may be included in a measurement report.

LMF 809 sends an adjustment 851 to the one or more network nodes 807. Adjustment 851 may indicate a measurement gap. The measurement gap may be based on a request for the measurement gap received in indication of determination to measure 841.

LMF 809 sends an adjustment 852 to UE 801. Adjustment 852 may indicate a measurement gap. The measurement gap may be based on a request for the measurement gap received in indication of determination to measure 841.

At 860, UE 801 measures one or more MEO RSs 861 received from MEO satellite 805 (e.g., for range-based positioning) and one or more LEO RSs 862 received from LEO satellite 804 (e.g., for doppler-based positioning). The measuring at 860 may be based on the measurement configuration 811 received from LMF 809. The measuring at 860 of the one or more LEO RSs 862 (for doppler-based positioning) may be based on the determining at 840. UE 801 sends a measurement report 863 to LMF 809 (e.g., via the one or more network nodes 807). The measurement report 863 may be analogous to measurement report 763 described above.

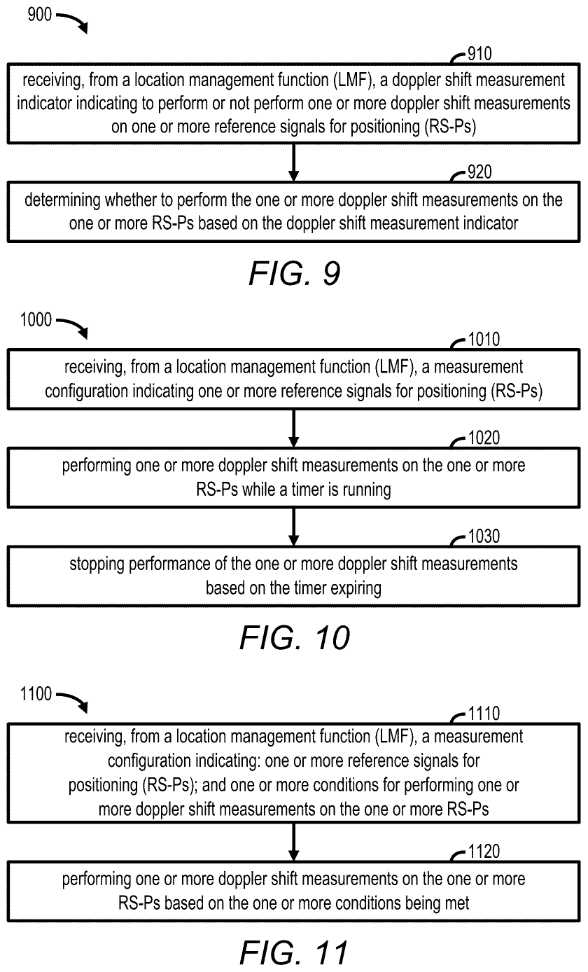

FIG. 9 illustrates an example method 900 of wireless positioning, according to aspects of the disclosure. In an aspect, method 900 may be performed by a UE (e.g., any of the UEs described herein).

At 910, the UE receives, from a location management function (LMF), a doppler shift measurement indicator indicating to perform or not perform one or more doppler shift measurements on one or more reference signals for positioning (RS-Ps).

In an aspect, operation 910 may be performed by the one or more WWAN transceivers 310, the one or more short-range wireless transceivers 320, the memory 340, the one or more processors 342, and/or the positioning component 348, any or all of which may be considered means for performing this operation.

At 920, the UE determines whether to perform the one or more doppler shift measurements on the one or more RS-Ps based on the doppler shift measurement indicator.

In an aspect, operation 920 may be performed by the one or more WWAN transceivers 310, the one or more short-range wireless transceivers 320, the memory 340, the one or more processors 342, and/or the positioning component 348, any or all of which may be considered means for performing this operation.

FIG. 10 illustrates an example method 1000 of wireless positioning, according to aspects of the disclosure. In an aspect, method 1000 may be performed by a UE (e.g., any of the UEs described herein).

At 1010, the UE receives, from a location management function (LMF), a measurement configuration indicating one or more reference signals for positioning (RS-Ps).

In an aspect, operation 1010 may be performed by the one or more WWAN transceivers 310, the one or more short-range wireless transceivers 320, the memory 340, the one or more processors 342, and/or the positioning component 348, any or all of which may be considered means for performing this operation.

At 1020, the UE performs one or more doppler shift measurements on the one or more RS-Ps while a timer is running.

In an aspect, operation 1020 may be performed by the one or more WWAN transceivers 310, the one or more short-range wireless transceivers 320, the memory 340, the one or more processors 342, and/or the positioning component 348, any or all of which may be considered means for performing this operation.

At 1030, the UE stops performance of the one or more doppler shift measurements based on the timer expiring.

In an aspect, operation 1030 may be performed by the one or more WWAN transceivers 310, the one or more short-range wireless transceivers 320, the memory 340, the one or more processors 342, and/or the positioning component 348, any or all of which may be considered means for performing this operation.

FIG. 11 illustrates an example method 1100 of wireless positioning, according to aspects of the disclosure. In an aspect, method 1100 may be performed by a UE (e.g., any of the UEs described herein).

At 1110, the UE receives, from a location management function (LMF), a measurement configuration indicating: one or more reference signals for positioning (RS-Ps); and one or more conditions for performing one or more doppler shift measurements on the one or more RS-Ps.

In an aspect, operation 1110 may be performed by the one or more WWAN transceivers 310, the one or more short-range wireless transceivers 320, the memory 340, the one or more processors 342, and/or the positioning component 348, any or all of which may be considered means for performing this operation.

At 1120, the UE performs one or more doppler shift measurements on the one or more RS-Ps based on the one or more conditions being met.

In an aspect, operation 1120 may be performed by the one or more WWAN transceivers 310, the one or more short-range wireless transceivers 320, the memory 340, the one or more processors 342, and/or the positioning component 348, any or all of which may be considered means for performing this operation.

As will be appreciated, a technical advantage of the methods 900, 1000, and 1100 is that doppler measurements may be dynamically performed (e.g., to perform high-accuracy positioning) or not performed (e.g., to conserve resources).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a user equipment (UE), comprising: receiving, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

Clause 2. The method of clause 1, further comprising: receiving the one or more RS-Ps from one or more low earth orbit (LEO) satellites associated with a non-terrestrial network (NTN).

Clause 3. The method of any of clauses 1 to 2, further comprising receiving, from the LMF, a measurement configuration indicating to perform: one or more range measurements on the one or more RS-Ps; and the one or more doppler shift measurements on the one or more RS-Ps; wherein the doppler shift measurement indicator comprises an indication to skip at least one of the one or more doppler shift measurements.

Clause 4. The method of clause 3, wherein the indication to skip comprises: an indication to skip at least a next doppler shift measurement of the one or more doppler shift measurements; an indication to start skipping the one or more doppler shift measurements; an indication of a skipping start time, a skipping end time, a skipping time duration, or any combination thereof, within which the UE does not perform the one or more doppler shift measurements; or any combination thereof.

Clause 5. The method of any of clauses 3 to 4, further comprising: skipping the one or more doppler shift measurements based on receiving the indication to start skipping; receiving an indication to resume the one or more doppler shift measurements; and performing the one or more doppler shift measurements based on receiving the indication to resume.

Clause 6. The method of any of clauses 1 to 5, wherein the doppler shift measurement indicator indicates a resolution for performing the one or more doppler shift measurements.

Clause 7. The method of clause 6, further comprising performing the one or more doppler shift measurements based on the indicated resolution.

Clause 8. The method of any of clauses 1 to 7, wherein the doppler shift measurement indicator is a satellite-specific indication corresponding to a satellite.

Clause 9. The method of any of clauses 1 to 8, wherein the doppler shift measurement indicator is a location-specific indication that indicates a location.

Clause 10. The method of clause 9, wherein the location is a geographic area, a geographic zone, a coverage area of a serving cell, a coverage area of a serving beam, or any combination thereof.

Clause 11. The method of any of clauses 9 to 10, further comprising: determining that the UE is at the location; and performing or not performing the one or more doppler shift measurements based on: the location-specific indication indicating the location; and the UE being at the location.

Clause 12. A user equipment (UE) comprising: one or more memories; one or more transceivers; and one or more processors communicatively coupled to the one or more memories and the one or more transceivers, the one or more processors, either alone or in combination, configured to: receive, via the one or more transceivers, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

Clause 13. The UE of clause 12, wherein the one or more processors, either alone or in combination, are further configured to: receive, via the one or more transceivers, the one or more RS-Ps from one or more low earth orbit (LEO) satellites associated with a non-terrestrial network (NTN).

Clause 14. The UE of any of clauses 12 to 13, wherein the one or more processors, either alone or in combination, are further configured to receive, via the one or more transceivers, from the LMF, a measurement configuration indicating to perform: one or more range measurements on the one or more RS-Ps; and the one or more doppler shift measurements on the one or more RS-Ps; wherein the doppler shift measurement indicator comprises an indication to skip at least one of the one or more doppler shift measurements.

Clause 15. The UE of clause 14, wherein the indication to skip comprises: an indication to skip at least a next doppler shift measurement of the one or more doppler shift measurements; an indication to start skipping the one or more doppler shift measurements; an indication of a skipping start time, a skipping end time, a skipping time duration, or any combination thereof, within which the UE does not perform the one or more doppler shift measurements; or any combination thereof.

Clause 16. The UE of any of clauses 14 to 15, wherein the one or more processors, either alone or in combination, are further configured to: skip the one or more doppler shift measurements based on receiving the indication to start skipping; receive, via the one or more transceivers, an indication to resume the one or more doppler shift measurements; and perform the one or more doppler shift measurements based on receiving the indication to resume.

Clause 17. The UE of any of clauses 12 to 16, wherein the doppler shift measurement indicator indicates a resolution for performing the one or more doppler shift measurements.

Clause 18. The UE of clause 17, wherein the one or more processors, either alone or in combination, are further configured to perform the one or more doppler shift measurements based on the indicated resolution.

Clause 19. The UE of any of clauses 12 to 18, wherein the doppler shift measurement indicator is a satellite-specific indication corresponding to a satellite.

Clause 20. The UE of any of clauses 12 to 19, wherein the doppler shift measurement indicator is a location-specific indication that indicates a location.

Clause 21. The UE of clause 20, wherein the location is a geographic area, a geographic zone, a coverage area of a serving cell, a coverage area of a serving beam, or any combination thereof.

Clause 22. The UE of any of clauses 20 to 21, wherein the one or more processors, either alone or in combination, are further configured to: determine that the UE is at the location; and perform or not performing the one or more doppler shift measurements based on: the location-specific indication indicating the location; and the UE being at the location.

Clause 23. A user equipment (UE) comprising: means for receiving, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

Clause 24. The UE of clause 23, further comprising: means for receiving the one or more RS-Ps from one or more low earth orbit (LEO) satellites associated with a non-terrestrial network (NTN).

Clause 25. The UE of any of clauses 23 to 24, further comprising means for receiving, from the LMF, a measurement configuration indicating to perform: one or more range measurements on the one or more RS-Ps; and the one or more doppler shift measurements on the one or more RS-Ps; wherein the doppler shift measurement indicator comprises an indication to skip at least one of the one or more doppler shift measurements.

Clause 26. The UE of clause 25, wherein the indication to skip comprises: an indication to skip at least a next doppler shift measurement of the one or more doppler shift measurements; an indication to start skipping the one or more doppler shift measurements; an indication of a skipping start time, a skipping end time, a skipping time duration, or any combination thereof, within which the UE does not perform the one or more doppler shift measurements; or any combination thereof.

Clause 27. The UE of any of clauses 25 to 26, further comprising: means for skipping the one or more doppler shift measurements based on receiving the indication to start skipping; means for receiving an indication to resume the one or more doppler shift measurements; and means for performing the one or more doppler shift measurements based on receiving the indication to resume.

Clause 28. The UE of any of clauses 23 to 27, wherein the doppler shift measurement indicator indicates a resolution for performing the one or more doppler shift measurements.

Clause 29. The UE of clause 28, further comprising means for performing the one or more doppler shift measurements based on the indicated resolution.

Clause 30. The UE of any of clauses 23 to 29, wherein the doppler shift measurement indicator is a satellite-specific indication corresponding to a satellite.

Clause 31. The UE of any of clauses 23 to 30, wherein the doppler shift measurement indicator is a location-specific indication that indicates a location.

Clause 32. The UE of clause 31, wherein the location is a geographic area, a geographic zone, a coverage area of a serving cell, a coverage area of a serving beam, or any combination thereof.

Clause 33. The UE of any of clauses 31 to 32, further comprising: means for determining that the UE is at the location; and means for performing or not performing the one or more doppler shift measurements based on: the location-specific indication indicating the location; and the UE being at the location.

Clause 34. A non-transitory computer-readable medium storing computer-executable instructions that, when executed by a user equipment (UE), cause the UE to: receive, from a location management function (LMF), a doppler shift measurement indicator indicating to perform or not perform one or more doppler shift measurements on one or more reference signals for positioning (RS-Ps); and determine whether to perform the one or more doppler shift measurements on the one or more RS-Ps based on the doppler shift measurement indicator.

Clause 35. The non-transitory computer-readable medium of clause 34, further comprising computer-executable instructions that, when executed by the UE, cause the UE to: receive the one or more RS-Ps from one or more low earth orbit (LEO) satellites associated with a non-terrestrial network (NTN).

Clause 36. The non-transitory computer-readable medium of any of clauses 34 to 35, further comprising computer-executable instructions that, when executed by the UE, cause the UE to receive, from the LMF, a measurement configuration indicating to perform: one or more range measurements on the one or more RS-Ps; and the one or more doppler shift measurements on the one or more RS-Ps; wherein the doppler shift measurement indicator comprises an indication to skip at least one of the one or more doppler shift measurements.

Clause 37. The non-transitory computer-readable medium of clause 36, wherein the indication to skip comprises: an indication to skip at least a next doppler shift measurement of the one or more doppler shift measurements; an indication to start skipping the one or more doppler shift measurements; an indication of a skipping start time, a skipping end time, a skipping time duration, or any combination thereof, within which the UE does not perform the one or more doppler shift measurements; or any combination thereof.

Clause 38. The non-transitory computer-readable medium of any of clauses 36 to 37, further comprising computer-executable instructions that, when executed by the UE, cause the UE to: skip the one or more doppler shift measurements based on receiving the indication to start skipping; receive an indication to resume the one or more doppler shift measurements; and perform the one or more doppler shift measurements based on receiving the indication to resume.

Clause 39. The non-transitory computer-readable medium of any of clauses 34 to 38, wherein the doppler shift measurement indicator indicates a resolution for performing the one or more doppler shift measurements.

Clause 40. The non-transitory computer-readable medium of clause 39, further comprising computer-executable instructions that, when executed by the UE, cause the UE to perform the one or more doppler shift measurements based on the indicated resolution.

Clause 41. The non-transitory computer-readable medium of any of clauses 34 to 40, wherein the doppler shift measurement indicator is a satellite-specific indication corresponding to a satellite.

Clause 42. The non-transitory computer-readable medium of any of clauses 34 to 41, wherein the doppler shift measurement indicator is a location-specific indication that indicates a location.

Clause 43. The non-transitory computer-readable medium of clause 42, wherein the location is a geographic area, a geographic zone, a coverage area of a serving cell, a coverage area of a serving beam, or any combination thereof.

Clause 44. The non-transitory computer-readable medium of any of clauses 42 to 43, further comprising computer-executable instructions that, when executed by the UE, cause the UE to: determine that the UE is at the location; and perform or not performing the one or more doppler shift measurements based on: the location-specific indication indicating the location; and the UE being at the location.

Clause 45. A method of wireless positioning performed by a user equipment (UE), comprising: receiving, from a location management function (LMF), a measurement configuration indicating one or more reference signals for positioning (RS-Ps); performing one or more doppler shift measurements on the one or more RS-Ps while a timer is running; and stopping performance of the one or more doppler shift measurements based on the timer expiring.

Clause 46. The method of clause 45, wherein the measurement configuration indicates a duration of the timer.

Clause 47. The method of any of clauses 45 to 46, further comprising: starting to perform the one or more doppler shift measurements; and starting the timer based on the starting to perform the one or more doppler shift measurements.

Clause 48. The method of clause 47, wherein the starting to perform is based on: receiving a message indicating to start performance of the one or more doppler shift measurements; determining to start performance of the one or more doppler shift measurements based on a periodicity indicated by the measurement configuration; or any combination thereof.

Clause 49. A user equipment (UE) comprising: one or more memories; one or more transceivers; and one or more processors communicatively coupled to the one or more memories and the one or more transceivers, the one or more processors, either alone or in combination, configured to: receive, via the one or more transceivers, from a location management function (LMF), a measurement configuration indicating one or more reference signals for positioning (RS-Ps); perform one or more doppler shift measurements on the one or more RS-Ps while a timer is running; and stop performance of the one or more doppler shift measurements based on the timer expiring.

Clause 50. The UE of clause 49, wherein the measurement configuration indicates a duration of the timer.

Clause 51. The UE of any of clauses 49 to 50, wherein the one or more processors, either alone or in combination, are further configured to: start to perform the one or more doppler shift measurements; and start the timer based on the starting to perform the one or more doppler shift measurements.

Clause 52. The UE of clause 51, wherein the starting to perform is based on: receive, via the one or more transceivers, a message indicating to start performance of the one or more doppler shift measurements; determine to start performance of the one or more doppler shift measurements based on a periodicity indicated by the measurement configuration; or any combination thereof.

Clause 53. A user equipment (UE) comprising: means for receiving, from a location management function (LMF), a measurement configuration indicating one or more reference signals for positioning (RS-Ps); means for performing one or more doppler shift measurements on the one or more RS-Ps while a timer is running; and means for stopping performance of the one or more doppler shift measurements based on the timer expiring.

Clause 54. The UE of clause 53, wherein the measurement configuration indicates a duration of the timer.

Clause 55. The UE of any of clauses 53 to 54, further comprising: means for starting to perform the one or more doppler shift measurements; and means for starting the timer based on the starting to perform the one or more doppler shift measurements.

Clause 56. The UE of clause 55, wherein the starting to perform is based on: means for receiving a message indicating to start performance of the one or more doppler shift measurements; means for determining to start performance of the one or more doppler shift measurements based on a periodicity indicated by the measurement configuration; or any combination thereof.

Clause 57. A non-transitory computer-readable medium storing computer-executable instructions that, when executed by a user equipment (UE), cause the UE to: receive, from a location management function (LMF), a measurement configuration indicating one or more reference signals for positioning (RS-Ps); perform one or more doppler shift measurements on the one or more RS-Ps while a timer is running; and stop performance of the one or more doppler shift measurements based on the timer expiring.

Clause 58. The non-transitory computer-readable medium of clause 57, wherein the measurement configuration indicates a duration of the timer.

Clause 59. The non-transitory computer-readable medium of any of clauses 57 to 58, further comprising computer-executable instructions that, when executed by the UE, cause the UE to: start to perform the one or more doppler shift measurements; and start the timer based on the starting to perform the one or more doppler shift measurements.

Clause 60. The non-transitory computer-readable medium of clause 59, wherein the starting to perform is based on: receive a message indicating to start performance of the one or more doppler shift measurements; determine to start performance of the one or more doppler shift measurements based on a periodicity indicated by the measurement configuration; or any combination thereof.

Clause 61. A method of wireless positioning performed by a user equipment (UE), comprising: receiving, via the one or more transceivers, from a location management function (LMF), a measurement configuration indicating: one or more reference signals for positioning (RS-Ps); and one or more conditions for performing one or more doppler shift measurements on the one or more RS-Ps; and performing one or more doppler shift measurements on the one or more RS-Ps based on the one or more conditions being met.

Clause 62. The method of clause 61, wherein the one or more conditions indicate a threshold number of visible satellites, and the performance of the one or more doppler shift measurements is based on a number of visible satellites being less-than or less-than-or-equal-to the threshold number.

Clause 63. The method of any of clauses 61 to 62, wherein the one or more conditions indicate a threshold signal quality, and the performance of the one or more doppler shift measurements is based on a signal quality of one or more satellites being less-than or less-than-or-equal-to the threshold signal quality.

Clause 64. The method of any of clauses 61 to 63, wherein the one or more conditions indicate a threshold geometric dilution of precision (GDOP), and the performance of the one or more doppler shift measurements is based on a GDOP of one or more satellites being greater than or greater-than-or-equal-to the threshold GDOP.

Clause 65. The method of any of clauses 61 to 64, further comprising sending, to the LMF: a request for a measurement gap; an indication of the performance of the one or more doppler shift measurements; an indication that the one or more conditions are met; or any combination thereof.

Clause 66. A user equipment (UE) comprising: one or more memories; one or more transceivers; and one or more processors communicatively coupled to the one or more memories and the one or more transceivers, the one or more processors, either alone or in combination, configured to: receive, via the one or more transceivers, via the one or more transceivers, from a location management function (LMF), a measurement configuration indicating: one or more reference signals for positioning (RS-Ps); and one or more conditions for performing one or more doppler shift measurements on the one or more RS-Ps; and perform one or more doppler shift measurements on the one or more RS-Ps based on the one or more conditions being met.

Clause 67. The UE of clause 66, wherein the one or more conditions indicate a threshold number of visible satellites, and the performance of the one or more doppler shift measurements is based on a number of visible satellites being less-than or less-than-or-equal-to the threshold number.

Clause 68. The UE of any of clauses 66 to 67, wherein the one or more conditions indicate a threshold signal quality, and the performance of the one or more doppler shift measurements is based on a signal quality of one or more satellites being less-than or less-than-or-equal-to the threshold signal quality.

Clause 69. The UE of any of clauses 66 to 68, wherein the one or more conditions indicate a threshold geometric dilution of precision (GDOP), and the performance of the one or more doppler shift measurements is based on a GDOP of one or more satellites being greater than or greater-than-or-equal-to the threshold GDOP.

Clause 70. The UE of any of clauses 66 to 69, wherein the one or more processors, either alone or in combination, are further configured to send, via the one or more transceivers, to the LMF: a request for a measurement gap; an indication of the performance of the one or more doppler shift measurements; an indication that the one or more conditions are met; or any combination thereof.

Clause 71. A user equipment (UE) comprising: means for receiving, via the one or more transceivers, from a location management function (LMF), a measurement configuration indicating: one or more reference signals for positioning (RS-Ps); and one or more conditions for performing one or more doppler shift measurements on the one or more RS-Ps; and means for performing one or more doppler shift measurements on the one or more RS-Ps based on the one or more conditions being met.

Clause 72. The UE of clause 71, wherein the one or more conditions indicate a threshold number of visible satellites, and the performance of the one or more doppler shift measurements is based on a number of visible satellites being less-than or less-than-or-equal-to the threshold number.

Clause 73. The UE of any of clauses 71 to 72, wherein the one or more conditions indicate a threshold signal quality, and the performance of the one or more doppler shift measurements is based on a signal quality of one or more satellites being less-than or less-than-or-equal-to the threshold signal quality.

Clause 74. The UE of any of clauses 71 to 73, wherein the one or more conditions indicate a threshold geometric dilution of precision (GDOP), and the performance of the one or more doppler shift measurements is based on a GDOP of one or more satellites being greater than or greater-than-or-equal-to the threshold GDOP.

Clause 75. The UE of any of clauses 71 to 74, further comprising means for sending, to the LMF: a request for a measurement gap; an indication of the performance of the one or more doppler shift measurements; an indication that the one or more conditions are met; or any combination thereof.

Clause 76. A non-transitory computer-readable medium storing computer-executable instructions that, when executed by a user equipment (UE), cause the UE to: receive, via the one or more transceivers, from a location management function (LMF), a measurement configuration indicating: one or more reference signals for positioning (RS-Ps); and one or more conditions for performing one or more doppler shift measurements on the one or more RS-Ps; and perform one or more doppler shift measurements on the one or more RS-Ps based on the one or more conditions being met.

Clause 77. The non-transitory computer-readable medium of clause 76, wherein the one or more conditions indicate a threshold number of visible satellites, and the performance of the one or more doppler shift measurements is based on a number of visible satellites being less-than or less-than-or-equal-to the threshold number.

Clause 78. The non-transitory computer-readable medium of any of clauses 76 to 77, wherein the one or more conditions indicate a threshold signal quality, and the performance of the one or more doppler shift measurements is based on a signal quality of one or more satellites being less-than or less-than-or-equal-to the threshold signal quality.

Clause 79. The non-transitory computer-readable medium of any of clauses 76 to 78, wherein the one or more conditions indicate a threshold geometric dilution of precision (GDOP), and the performance of the one or more doppler shift measurements is based on a GDOP of one or more satellites being greater than or greater-than-or-equal-to the threshold GDOP.

Clause 80. The non-transitory computer-readable medium of any of clauses 76 to 79, further comprising computer-executable instructions that, when executed by the UE, cause the UE to send, to the LMF: a request for a measurement gap; an indication of the performance of the one or more doppler shift measurements; an indication that the one or more conditions are met; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A user equipment (UE) comprising:
one or more memories;
one or more transceivers; and
one or more processors communicatively coupled to the one or more memories and the one or more transceivers, the one or more processors, either alone or in combination, configured to:
receive, via the one or more transceivers, from a location management function (LMF), a doppler shift measurement indicator indicating to perform or not perform one or more doppler shift measurements on one or more reference signals for positioning (RS-Ps); and
determine whether to perform the one or more doppler shift measurements on the one or more RS-Ps based on the doppler shift measurement indicator.

2. The UE of claim 1, wherein the one or more processors, either alone or in combination, are further configured to:
receive, via the one or more transceivers, the one or more RS-Ps from one or more low earth orbit (LEO) satellites associated with a non-terrestrial network (NTN).

3. The UE of claim 1, wherein:
the one or more processors, either alone or in combination, are further configured to receive, via the one or more transceivers, from the LMF, a measurement configuration indicating to perform:
one or more range measurements on the one or more RS-Ps; and
the one or more doppler shift measurements on the one or more RS-Ps; and
the doppler shift measurement indicator comprises an indication to skip at least one of the one or more doppler shift measurements.

4. The UE of claim 3, wherein the indication to skip comprises:
an indication to skip at least a next doppler shift measurement of the one or more doppler shift measurements;
an indication to start skipping the one or more doppler shift measurements;
an indication of a skipping start time, a skipping end time, a skipping time duration, or any combination thereof, within which the UE does not perform the one or more doppler shift measurements; or
any combination thereof.

5. The UE of claim 3, wherein the one or more processors, either alone or in combination, are further configured to:
skip the one or more doppler shift measurements based on receiving the indication to start skipping;
receive, via the one or more transceivers, an indication to resume the one or more doppler shift measurements; and
perform the one or more doppler shift measurements based on receiving the indication to resume.

6. The UE of claim 1, wherein the doppler shift measurement indicator indicates a resolution for performing the one or more doppler shift measurements.

7. The UE of claim 6, wherein the one or more processors, either alone or in combination, are further configured to perform the one or more doppler shift measurements based on the indicated resolution.

8. The UE of claim 1, wherein the doppler shift measurement indicator is a satellite-specific indication corresponding to a satellite.

9. The UE of claim 1, wherein the doppler shift measurement indicator is a location-specific indication that indicates a location.

10. The UE of claim 9, wherein the location is a geographic area, a geographic zone, a coverage area of a serving cell, a coverage area of a serving beam, or any combination thereof.

11. The UE of claim 9, wherein the one or more processors, either alone or in combination, are further configured to:
determine that the UE is at the location; and
perform or not perform the one or more doppler shift measurements based on:
the location-specific indication indicating the location; and
the UE being at the location.

12. A user equipment (UE) comprising:
one or more memories;
one or more transceivers; and
one or more processors communicatively coupled to the one or more memories and the one or more transceivers, the one or more processors, either alone or in combination, configured to:
receive, via the one or more transceivers, from a location management function (LMF), a measurement configuration indicating one or more reference signals for positioning (RS-Ps);
perform one or more doppler shift measurements on the one or more RS-Ps while a timer is running; and
stop performance of the one or more doppler shift measurements based on the timer expiring.

13. The UE of claim 12, wherein the measurement configuration indicates a duration of the timer.

14. The UE of claim 12, wherein the one or more processors, either alone or in combination, are further configured to:
start to perform the one or more doppler shift measurements; and
start the timer based on the starting to perform the one or more doppler shift measurements.

15. The UE of claim 14, wherein the starting to perform is based on:
receive, via the one or more transceivers, a message indicating to start performance of the one or more doppler shift measurements;
determine to start performance of the one or more doppler shift measurements based on a periodicity indicated by the measurement configuration; or
any combination thereof.

16. A user equipment (UE) comprising:
one or more memories;
one or more transceivers; and
one or more processors communicatively coupled to the one or more memories and the one or more transceivers, the one or more processors, either alone or in combination, configured to:
receive, via the one or more transceivers, from a location management function (LMF), a measurement configuration indicating:
one or more reference signals for positioning (RS-Ps); and
one or more conditions for performing one or more doppler shift measurements on the one or more RS-Ps; and
perform one or more doppler shift measurements on the one or more RS-Ps based on the one or more conditions being met.

17. The UE of claim 16, wherein the one or more conditions indicate a threshold number of visible satellites, and the performance of the one or more doppler shift measurements is based on a number of visible satellites being less-than or less-than-or-equal-to the threshold number.

18. The UE of claim 16, wherein the one or more conditions indicate a threshold signal quality, and the performance of the one or more doppler shift measurements is based on a signal quality of one or more satellites being less-than or less-than-or-equal-to the threshold signal quality.

19. The UE of claim 16, wherein the one or more conditions indicate a threshold geometric dilution of precision (GDOP), and the performance of the one or more doppler shift measurements is based on a GDOP of one or more satellites being greater than or greater-than-or-equal-to the threshold GDOP.

20. The UE of claim 16, wherein the one or more processors, either alone or in combination, are further configured to send, via the one or more transceivers, to the LMF:
a request for a measurement gap;
an indication of the performance of the one or more doppler shift measurements;
an indication that the one or more conditions are met; or
any combination thereof.
